(19) United States
(12) Patent Application Publication
(10) Pub. No.: US 2021/0295815 A1
(43) Pub. Date: Sep. 23, 2021

(54) SOUND OUTPUT DEVICE

(71) Applicant: Sony Corporation, Tokyo (JP)

(72) Inventors: Yushi Yamabe, Tokyo (JP); Naoki Shinmen, Tokyo (JP); Kenichi Oide, Tokyo (JP)

(73) Assignee: Sony Corporation, Tokyo (JP)

(21) Appl. No.: 17/263,113

(22) PCT Filed: Jul. 25, 2019
(86) PCT No.: PCT/JP2019/029288

§ 371 Date: Jan. 25, 2021

(30) Foreign Application Priority Data
Aug. 3, 2018 (JP) 2018-147179

(51) Int. Cl. G10K 11/178; H04R 1/34; H04R 1/08; H04R 1/10

(52) U.S. Cl. CPC G10K 11/17881; H04R 1/345; H04R 1/08; G10K 2210/3028; G10K 2210/1081; G10K 2210/3026; G10K 2210/3027; H04R 1/10

(57) ABSTRACT

A sound output device according to an embodiment includes: an acoustic path (70) and a microphone (100b). The acoustic path connects a first space (54b) formed on a front surface of a driver unit (106) and the outside of a housing (50b) including the driver unit separately from a second space (55b) formed on a back surface of the driver unit. The microphone is disposed in the vicinity of an opening where the acoustic path is connected to the outside of the housing.

### FIELD

The present invention relates to a sound output device.

### BACKGROUND

When earphones or headphones are worn, a need exists for reduction of sound (extraneous noise) reaching a pinna from the outside of the earphones or the headphones. Thus, a noise cancelling system that removes noise by signal processing based on an audio signal output from a microphone provided in a housing of an earphone or a headphone has been known.

### CITATION LIST

### Patent Literature

Patent Literature 1: Japanese Patent Application Laid-open No. 2016-086281

Patent Literature 2: Japanese Patent Application Laid-open No. 2017-120447

Patent Literature 3: National Publication of International Patent Application No. 2017-509284

### SUMMARY

### Technical Problem

The above noise cancelling system has room for improvement regarding system stability and noise attenuation.

The present disclosure proposes a sound output device capable of further reducing extraneous noise.

### Solution to Problem

For solving the problem described above, a sound output device according to one aspect of the present disclosure has an acoustic path connecting a first space on a front surface of a driver unit and an outside of a housing including the driver unit separately from a second space on a back surface of the driver unit, and a microphone disposed in the vicinity of an opening where the acoustic path is connected to the outside of the housing.

### Advantageous Effects of Invention

The present disclosure can further reduce extraneous noise. Note that the present disclosure does not necessarily have to be limited to the effect described above and may provide any effect described in the present disclosure.

### BRIEF DESCRIPTION OF DRAWINGS

FIG. 1A is a view illustrating a configuration example of a noise cancelling system using a feedback technique.

FIG. 1B is a view illustrating the configuration example of the noise cancelling system using the feedback technique.

FIG. 1C is a view illustrating the configuration example of the noise cancelling system using the feedback technique.

FIG. 2 is a view illustrating a bode plot.

FIG. 3A is a view illustrating a configuration example of a noise cancelling system using an FF technique.

FIG. 3B is a view illustrating the configuration example of the noise cancelling system using the FF technique.

FIG. 3C is a view illustrating the configuration example of the noise cancelling system using the FF technique.

FIG. 4A is a view illustrating a configuration of an earphone example according to an existing technique.

FIG. 4B is a view illustrating the configuration of the earphone example according to the existing technique.

FIG. 4C is a view illustrating the configuration of the earphone example according to the existing technique.

FIG. 5A is a view illustrating a configuration of an earphone example according to a first embodiment.

FIG. 5B is a view illustrating the configuration of the earphone example according to the first embodiment.

FIG. 5C is a view illustrating the configuration of the earphone example according to the first embodiment.

FIG. 5D is a view illustrating a configuration of another earphone example according to the first embodiment.

FIG. 5E is a view illustrating the configuration of the earphone example according to the first embodiment.

FIG. 6 is a view for explaining an effect according to the first embodiment.

FIG. 7A is a view illustrating a configuration of an earphone example according to a first modification of the first embodiment.

FIG. 7B is a view schematically illustrating a structure of a driver unit example.

FIG. 8 is a view illustrating a configuration of an earphone example according to a second modification of the first embodiment.

FIG. 9 is a view illustrating a configuration of an earphone example according to a third modification of the first embodiment.

FIG. 10 is a view illustrating a configuration of a headphone example according to a second embodiment.

FIG. 11 is a view illustrating a configuration of a headphone example according to a first modification of the second embodiment.

FIG. 12 is a view illustrating a configuration of a headphone example according to a second modification of the second embodiment.

FIG. 13 is a view illustrating a configuration of a headphone example according to a third modification of the second embodiment.

FIG. 14 is a view illustrating a configuration of a headphone example according to a fourth modification of the second embodiment.

FIG. 15A is a view for explaining a position where a microphone is disposed.

FIG. 15B is a view for explaining another position where the microphone is disposed.

FIG. 15C is a view for explaining another position where the microphone is disposed.

### DESCRIPTION OF EMBODIMENTS

Hereinafter, embodiments of the present disclosure will be described in detail based on the drawings. Note that the same components are denoted by the same reference numerals to omit the overlapping description in the following respective embodiments.

[Outline of the Present Disclosure]

Examples of a sound output device according to the present disclosure include an over-ear (or on-ear) type headphone (hereinafter headphone) that delivers, to a pinna from the vicinity thereof, sound generated with a diaphragm vibrating according to an audio signal in a driver unit, and a classic (or in-ear) type earphone (hereinafter earphone) that directly delivers the sound to the pinna. The sound output device is also provided with a microphone capable of collecting sound (extraneous noise) reaching from the outside of a housing including the driver unit. The sound output device corresponds to a noise cancelling system capable of reducing noise included in the sound delivered to the pinna by using an audio signal based on the noise collected by the microphone.

Before describing the present disclosure, a basic configuration of the noise cancelling system applied to the headphone and the earphone will be described in order to facilitate understanding.

(Feedback Noise Cancelling System)

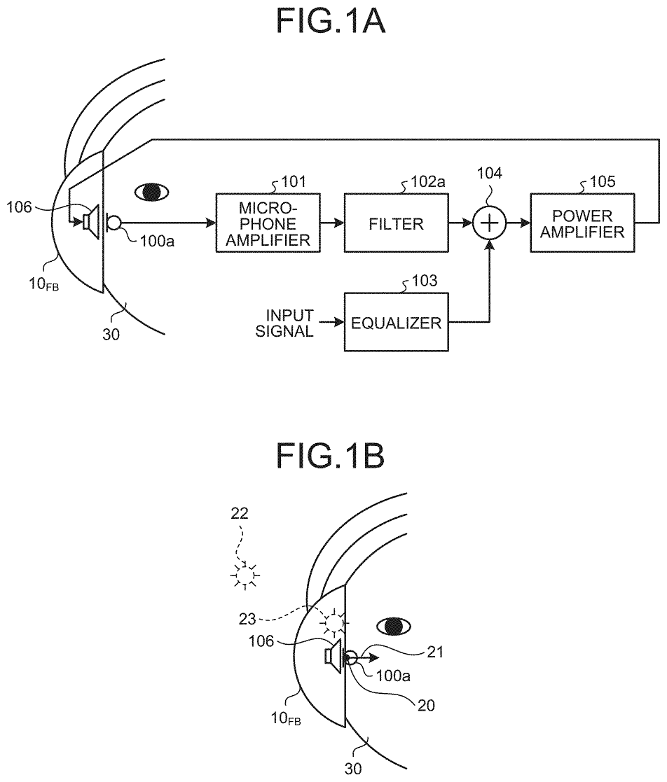

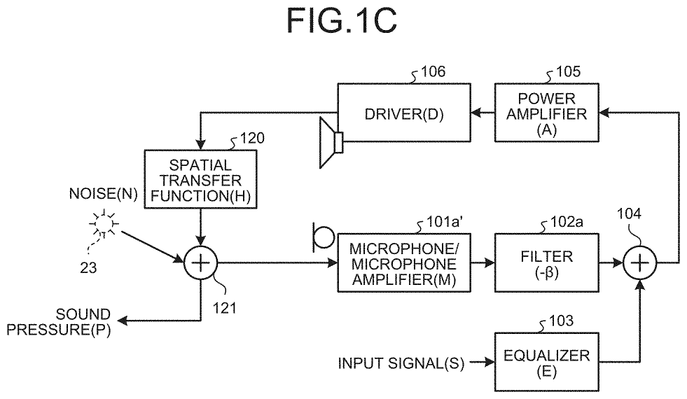

First, a noise cancelling system using an existing feedback (hereinafter FB) technique will be described. FIGS. 1A, 1B, and 1C are views illustrating a configuration example of the feedback noise cancelling system.

FIG. 1A is a block diagram illustrating a configuration of an electrical circuit example of the FB noise cancelling system. In this example, an over-head type headphone 10_{FB} used by being worn on a head 30 of a listener is used as the sound output device. The headphone 10_{FB} includes a microphone 100a and a driver unit 106. The driver unit 106 includes, for example, a diaphragm, and generates air vibration based on an audio signal supplied thereto with the diaphragm vibrating according to the audio signal, thereby outputting sound.

In the headphone 10_{FB}, a space on the pinna side of the driver unit 106 and a space facing this space via the driver unit 106 are typically separated by a partition wall or the like. Note that a surface on the pinna side of the driver unit 106 is hereinafter referred to as a front surface and a surface facing the front surface as a back surface.

The microphone 100a is disposed in the front-surface space of the driver unit 106 on the inside of a housing (housing portion) of the headphone 10_{FB} so as to collect sound within the space. In other words, the microphone 100a directly collects the sound within the space, i.e., sound to be guided to the pinna of the listener. An audio signal based on the sound collected by the microphone 100a is supplied to a filter 102a corresponding to the FB technique, which will be described in detail later, through a microphone amplifier 101. The audio signal filtered by the filter 102a is supplied to an adder 104.

Meanwhile, an input signal according to an audio signal as a sound source is supplied to the adder 104 through an equalizer 103 having a characteristic described in detail later. The adder 104 supplies an audio signal obtained by adding the output of the filter 102a and the output of the equalizer 103 to a power amplifier 105. The power amplifier 105 power-amplifies the supplied audio signal and supplies this signal to the driver unit 106. The driver unit 106 is driven according to the audio signal supplied from the power amplifier 105, outputting sound. The microphone 100a collects the sound output by the driver unit 106 and sound (extraneous noise) reaching from the outside of the headphone 10_{FB}.

FIG. 1B is a view for explaining each sound related to the headphone 10_{FB}. In FIG. 1B, a noise 22 is the extraneous noise from a noise source outside the headphone 10_{FB}. Additionally, a noise 23 is the noise 22 entering the inside of the headphone 10_{FB}. In the headphone 10_{FB}, the noise 23 and a sound pressure 21 generated based on the audio signal in the driver unit 106 reach the pinna on the head 30 on which the headphone 10_{FB} is worn.

A control point 20 indicates a position to reduce the noise 23 in the noise cancelling system including the headphone 10_{FB}. In the case of the FB technique, the control point 20 is located at the microphone 100a as illustrated in FIG. 1B. Thus, typically, the microphone 100a is placed at a position close to the pinna, e.g., on the front surface of the diaphragm of the driver unit 106.

FIG. 1C is a view defining a transfer function for each portion of the configuration illustrated in FIG. 1A. Note that the driver unit 106 is illustrated as “driver 106” in FIG. 1C. As shown in parentheses attached to the name of each block, “M” represents the transfer function of a microphone/microphone amplifier 101a′ combining the microphone 100a and the microphone amplifier 101, “−β” represents the transfer function of the filter 102a, “A” represents the transfer function of the power amplifier, “D” represents the transfer function of the driver 106, and “E” represents the transfer function of the equalizer 103. Additionally, “H” represents a spatial transfer function 120 that is a transfer function from the driver 106 to the microphone 100a. Note that each transfer function is represented by a complex number.

Moreover, “N” represents the noise 23 that is the external noise 22 illustrated in FIG. 1B entering the inside of the headphone 10_{FB}. A reason why the noise 22 is transmitted to the inside of the headphone 10_{FB} is considered that the noise leaks as a sound pressure from, for example, a gap in an earpad portion of the headphone 10_{FB} (an earpiece portion in the case of in-ear type) disposed in contact with skin. The reason may be also that the noise is transmitted to the inside of the housing of the headphone 10_{FB} as a result of vibration of the housing upon receiving a sound pressure from a hole formed in communication with the outside from the front surface of the headphone 10_{FB}.

An adder 121 indicates that the output of the driver unit 106 and the noise 23 are collected by the microphone 100a, and corresponds to the control point 20. That is, the spatial transfer function “H” is equivalent to a transfer function from the driver unit 106 to the control point 20. Additionally, sound obtained by adding the output of a driver unit 106b and the noise 23 reaches the pinna as a sound pressure. The sound pressure is represented by “P”. Additionally, the input signal is represented by “S”.

A relation among the respective blocks in FIG. 1C can be expressed by the following equation (1) using the transfer functions.

$$P = \frac{1}{1 + A D H M β} N + \frac{A H D}{1 + A D H M β} E S \qquad ( 1 )$$

Focusing on “N” representing the noise 23 in the equation (1), it is understood that the noise 23 is attenuated to “1/(1+ADHMβ)”. For the system of the equation (1) to operate stably without oscillation, a condition expressed by the following equation (2) needs to be satisfied.

$$\vert \frac{1}{1 + A D H M β} \vert < 1 \qquad ( 2 )$$

In combination with 1<<|ADMHβ| in general, the equation (2) can be interpreted as follows.

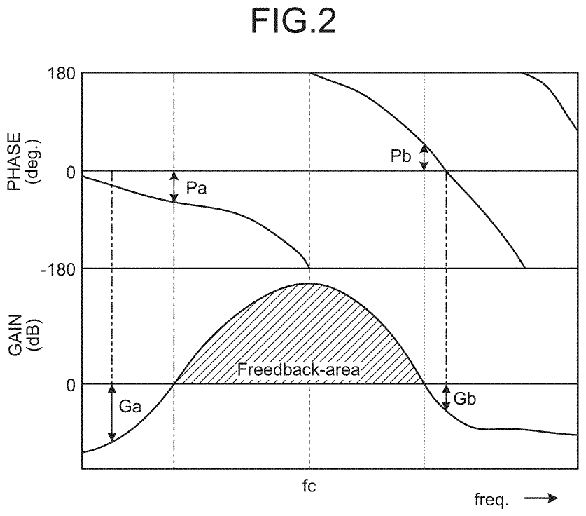

“−ADMHβ” obtained by disconnecting one point in a loop portion related to “N” representing the noise 23 in FIG. 1C is referred to as an open loop, which has a characteristic as indicated by, for example, a bode plot of FIG. 2. When the open loop is targeted, the condition according to the above equation (2) needs to satisfy the following two conditions (1) and (2).

(1) The gain should be lower than 0 [dB] when the phase passes a point of 0 [deg].

(2) The phase should not include a point of 0 [deg] when the gain is 0 [dB] or higher.

When the above conditions (1) and (2) are not satisfied, positive feedback is effected in the loop to cause oscillation (howling). In FIG. 2, margins Pa and Pb represent phase margins, and margins Ga and Gb represent gain margins. When the margins Pa and Pb and the margins Ga and Gb are small, the risk of oscillation is increased depending on, for example, individual differences in face shape or variations in wearing state of the headphone 10_{FB}.

Next, reproduction of sound according to the input signal from the headphone 10_{FB} will be described in addition to the above-described function of reducing the noise reaching from the outside. The input signal “S” in FIG. 1C is an audio signal based on original sound to be reproduced by the driver unit 106 of the headphone 10_{FB}, and includes an audio signal such as a music signal, sound of a microphone outside the housing (a use example as a hearing aid function), and a speech signal through communication (a use example as a headset).

Focusing on the input signal “S” in the above equation (1), the sound pressure “P” is expressed by the following equation (4) by setting the transfer function “E” of the equalizer 103 as in the following equation (3).

E=(1+ADHMβ) (3)

$$P = \frac{1}{1 + A D H M β} N + AHDS \qquad ( 4 )$$

When the microphone 100a is placed very close to the pinna, the transfer function “H” can be considered as a transfer function from the driver unit 106 to the microphone 100a (pinna). Here, the transfer functions “A” and “D” are the transfer functions of the power amplifier 105 and the driver unit 106, respectively. Thus, it is understood that a characteristic similar to that of a headphone with no noise reducing function is obtained. Note that the equalizer 103 at this time has a substantially inverse characteristic from the open loop characteristic as viewed on a frequency axis.

(Feed-Forward Noise Cancelling System)

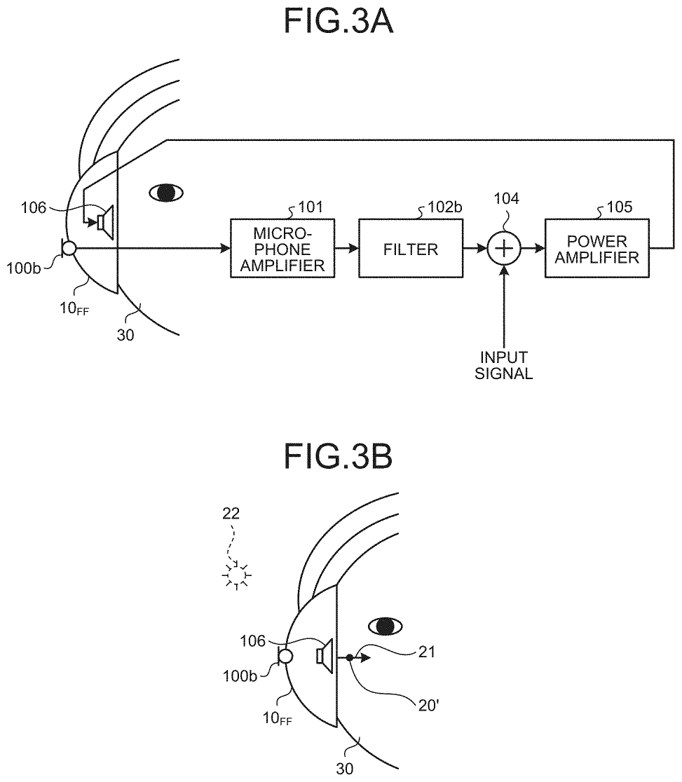

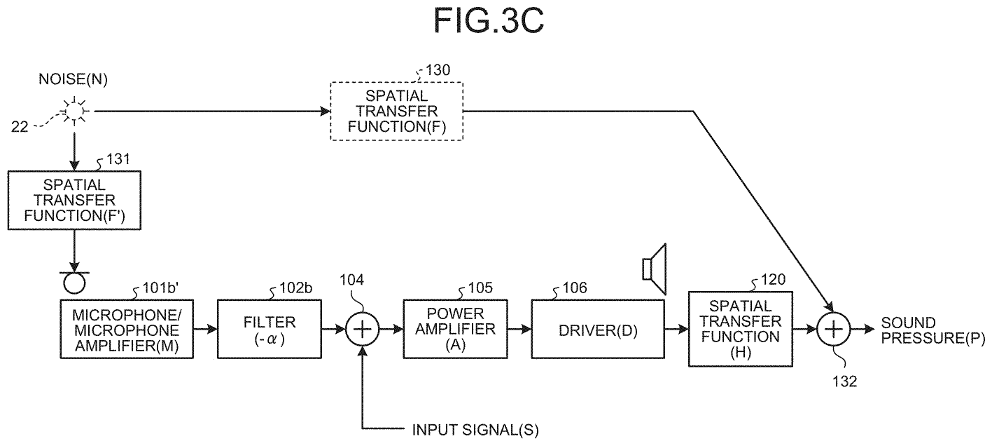

Next, a noise cancelling system using an existing feed-forward (hereinafter FF) technique will be described. FIGS. 3A, 3B, and 3C are views illustrating a configuration example of the FF noise cancelling system.

FIG. 3A is a block diagram illustrating a configuration of an electrical circuit example of the FF noise cancelling system. In the configuration illustrated in FIG. 3A, the equalizer 103 is omitted and a filter 102b having a characteristic corresponding to the FF technique is provided instead of the filter 102a as compared with the above configuration illustrated in FIG. 1A. The input signal is directly input into the adder 104. Additionally, in a headphone 10_{FF}, a microphone 100b for collecting extraneous noise is placed on a surface of the housing of the headphone 10_{FF}. An omni-directional microphone is used as the microphone 100b.

FIG. 3B is a view for explaining each sound related to the headphone 10_{FF}. In FIG. 3B, the microphone 100b collects the noise 22 from the noise source outside the headphone 10_{FF}. Moreover, in the example of FIG. 3B, a control point 20′ is placed at a position close to the pinna on the front surface of the driver unit 106 similarly to the headphone 10_{FB} illustrated in FIG. 1B. In the FF technique, the control point 20′ can be set at any pinna position of the listener.

FIG. 3C is a view defining a transfer function for each portion of the configuration illustrated in FIG. 3A. Note that the driver unit 106 is illustrated as “driver 106” in FIG. 3C. In this example, “M” represents the transfer function of a microphone/microphone amplifier 101b′ combining the microphone 100b and the microphone amplifier 101. Additionally, “−α” represents the transfer function of the filter 102b, and “H” represents the spatial transfer function 120 from the driver unit 106 to an adder 132 corresponding to the control point 20. Moreover, “F” represents a spatial transfer function 130 of the noise 22 as the extraneous noise reaching the control point 20 (the adder 132) through the housing of the headphone 10_{FF}, and “F′” represents a spatial transfer function 131 of the noise 22 reaching the microphone 100b.

A relation among the respective blocks in FIG. 3C can be expressed by the following equation (5) using the transfer functions.

P=−F′ADHMαN+FN+ADHS (5)

Here, the spatial transfer function “F” (the spatial transfer function 130) is expressed as in the following equation (6) in consideration of an ideal state. In this case, the above equation (5) can be expressed as in the following equation (7).

F=F′ADHMα (6)

P=ADHS (7)

According to the equation (7), the input signal “S” is left in the sound pressure “P”, which does not include the noise “N”. Thus, it is understood that the noise is cancelled, and sound equivalent to that in a normal headphone operation (i.e., an operation in a state in which the external noise 22 is not present) can be listened to.

Unfortunately, it is practically difficult to configure the perfect filter 102b having the transfer function “−α” that perfectly satisfies the equation (6). Especially in a mid-to-high frequency range, the characteristic changes due to large individual differences in wearing state and ear shape among listeners, and depending on the position of the source of the noise 22, and the position of the microphone 100b. Thus, in the mid-to-high frequency range, the active noise reducing process according to FIG. 3C is not normally performed, but passive sound isolation is often performed by, for example, increasing sealing performance against external noise in the housing of the headphone 10_{FF}.

Note that the equation (6) means that the spatial transfer function “F′” (the spatial transfer function 131) from the noise source of the noise 22 to the pinna position is imitated in the electrical circuit including the transfer function “−α” of the filter 102b.

As described above, in the FF technique, the control point 20′ can be set at any pinna position of the listener. Meanwhile, the transfer function “−α” of the filter 102b is typically fixed, and it is necessary to design the filter 102b in a limited manner aiming at some target characteristic in design stage. In this case, there is a possibility that a sufficient noise cancelling effect cannot be obtained due to the pinna shape of each listener being different from that expected at the time of design, or that a noise component is added in non-reverse phase, resulting in a phenomenon such as occurrence of unusual sound.

Based on the above description, while the FF technique typically achieves a low risk of oscillation and high stability, it is difficult to achieve sufficient noise attenuation. Meanwhile, the FB technique, which is expected to achieve high attenuation, is inferior to the FF technique regarding the stability of the system.

A noise cancelling system using a method of adaptive signal processing has also been proposed. The noise cancelling system using the method of adaptive signal processing is typically provided with a microphone on, for example, both of the inside and the outside of the headphone housing. The microphone provided on the inside of the headphone is used in analyzing an error signal intended for cancellation with a filtered component, and generating a new adaptive filter by updating its coefficients. Basically, noise outside the headphone housing is digitally filtered and the obtained sound is reproduced in the driver unit. Thus, it can be roughly said that the noise cancelling system using the method of adaptive signal processing uses the FF technique. Unfortunately, the noise cancelling system using the method of adaptive signal processing has a problem of system stability and a cost-effectiveness problem due to a large processing scale.

Therefore, the present disclosure intends to improve the characteristics by the noise cancellation using the FF technique.

### First Embodiment

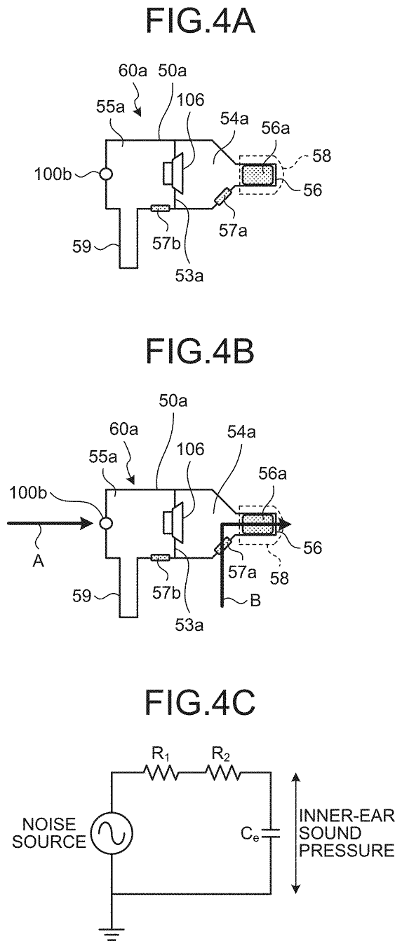

Next, a first embodiment will be described. In the first embodiment, the sound output device according to the present disclosure will be described as an in-ear type earphone (hereinafter referred to as earphone). First, a configuration of an earphone performing the noise cancellation using the FF technique, according to an existing technique, will be described in contrast to the earphone according to the present disclosure. FIGS. 4A, 4B, and 4C are views illustrating a configuration of an earphone example according to the existing technique.

In FIG. 4A, an earphone 60a according to the existing technique includes a sound output port 56 that guides sound output from the driver unit 106 to the pinna, and a cylindrical portion 59 to which a wire for supplying an audio signal to the driver unit 106 is connected. For example, an opening of the sound output port 56 has a smaller area than the front surface of the driver unit 106. The driver unit 106 is a dynamic-type driver unit including a voice coil, a magnet, and the diaphragm and outputting sound with the diaphragm vibrating according to the audio signal input into the voice coil.

A partition wall 53a for separating the front surface and the back surface of the driver unit 106 is disposed within a housing 50a of the earphone 60a. The inside of the housing 50a of the earphone 60a is divided into a space 54a (first space) on the front surface side of the driver unit 106 and a space 55a (second space) on the back surface side thereof by the driver unit 106 and the partition wall 53a.

Here, the front surface of the driver unit 106 is a surface of the driver unit 106 on a side spatially directly connected to the sound output port 56. The back surface of the driver unit 106 is a surface of the driver unit 106 on an opposite side to the front surface.

As illustrated in FIG. 4A, a vent hole 57a connecting the front-surface space 54a and the outside, and a vent hole 57b connecting the back-surface space 55a and the outside are disposed at predetermined positions of the housing 50a. The vent hole 57a is provided for lessening a pressure load on an eardrum, reducing individual differences in output sound, or the like when the earphone 60a is worn on the pinna of the listener to output sound. In the example of FIG. 4A, the vent hole 57a is disposed in a wall of the housing 50a constituting the front-surface space 54a. Additionally, the vent hole 57b is provided for lessening a load on the diaphragm of the driver unit 106 in, for example, outputting sound.

Actually, a ventilation resistance body 56a made of, for example, compressed urethane or non-woven fabric is provided within the sound output port 56. Moreover, an earpiece 58 made of urethane or silicone rubber is typically attached to the sound output port 56 to adjust a size for the pinna and improve adhesion to the pinna.

The microphone 100b for sound collection using the FF technique is also disposed on, for example, the surface of the housing 50a of the earphone 60a.

FIG. 4B is a view illustrating an action example of the noise 22 for the earphone 60a having the configuration in FIG. 4A. The noise 22 is collected by the microphone 100b as indicated by a path A. The noise 22 is also input into the front-surface space 54a from the vent hole 57a and guided to the pinna through the sound output port 56 from the front-surface space 54a as indicated by a path B.

FIG. 4C illustrates an example of an acoustic equivalent circuit of a sound isolation path for performing sound isolation of the noise 22 based on the structure in FIG. 4B. In FIG. 4C, a capacitor Cₑ is an ear canal volume of the pinna where the earphone 60a is worn, and a sound pressure supplied to the capacitor Cₑ is an inner-ear sound pressure. The noise 22 from the noise source is supplied to the capacitor Cₑ through acoustic resistance R₁ by the vent hole 57a and acoustic resistance R₂ by the ventilation resistance body 56a.

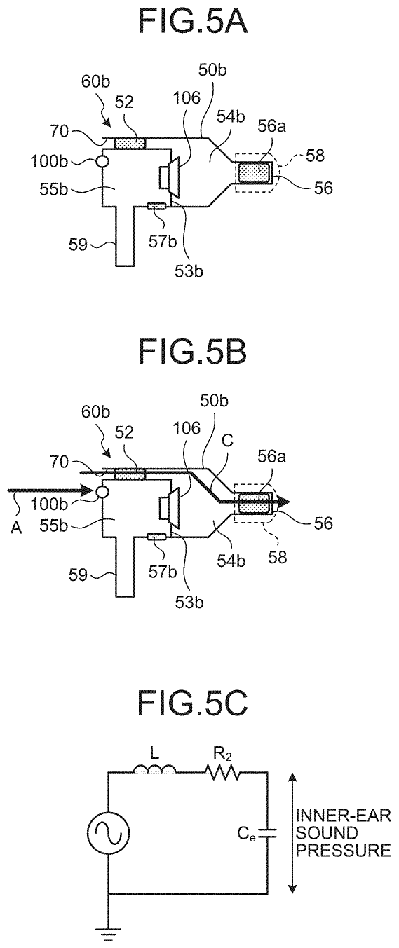

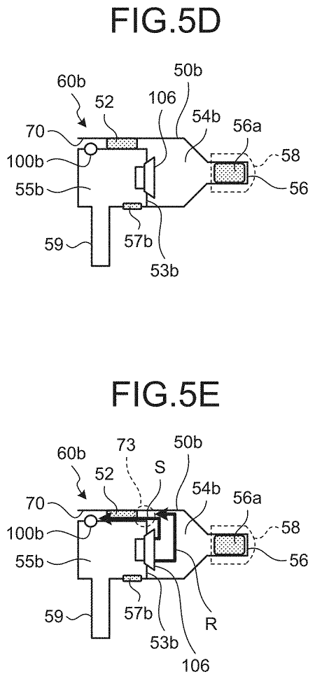

FIGS. 5A, 5B, and 5C are views illustrating a configuration of an earphone example according to the first embodiment. In an earphone 60b according to the first embodiment illustrated in FIG. 5A, a partition wall 53b separates the front surface and the back surface of the driver unit 106 to form a front-surface space 54b and a back-surface space 55b.

Here, in the earphone 60b according to the first embodiment, the front-surface space 54b and the outside of a housing 50b are connected by an acoustic path 70 that is separated from the back-surface space 55b. The noise 22 is collected by the microphone 100b as indicated by the path A. The noise 22 is also input from a connection portion of the acoustic path 70 on the surface of the housing 50b of the earphone 60b as indicated by a path C. The connection portion is an opening formed in the surface of the housing 50b. The noise 22 is input into the front-surface space 54a through the acoustic path 70 and guided to the pinna through the sound output port 56 from the front-surface space 54a. For example, an opening of the sound output port 56 has a smaller area than the front surface of the driver unit 106.

For example, a cylinder that is opened at an end connected to the partition wall 53b and an end connected to the outside of the housing 50b can be used as the acoustic path 70. Additionally, in the first embodiment, the acoustic path 70 is disposed at a position not in contact with the driver unit 106. A ventilation resistance body 52 made of, for example, urethane foam or non-woven fabric is preferably provided within the acoustic path 70 or around the connection portion (opening). The connection portion (opening) may be also covered with a lid made of metal or synthetic resin where a plurality of holes are formed.

Note that the acoustic path 70 may have a shape other than the cylindrical shape, such as a shape whose cross section has an oval, rectangular, triangular, or pentagonal or more polygonal shape. Additionally, the acoustic path 70 is not limited to the shape directly connecting the partition wall 53b and a connection position with the outside of the housing 50b and may have any shape that is topologically equivalent.

FIG. 5C illustrates an example of an acoustic equivalent circuit of a sound isolation path for performing sound isolation of the noise 22, according to the first embodiment based on the structure in FIG. 5B. In FIG. 5C, the noise 22 from the noise source is supplied to the capacitor Cₑ through inductance L by the acoustic path 70 and the acoustic resistance R₂ by the ventilation resistance body 56a.

When FIG. 5C and FIG. 4C described above are compared, the inductance L by the acoustic path 70 is connected in the equivalent circuit in FIG. 5C instead of the acoustic resistance R₁ by the vent hole 57a in the equivalent circuit in FIG. 4C. Meanwhile, the acoustic resistance R₂ by the ventilation resistance body 56a is considered to be common in FIG. 4C and FIG. 5C. In the equivalent circuit in FIG. 5C, a mid-to-high-frequency component is attenuated by the inductance L. Thus, a high passive attenuation effect can be expected.

In the earphone 60b according to the first embodiment, the microphone 100b for noise collection using the FF technique is further disposed in the vicinity of the connection portion (opening) where the acoustic path 70 is connected to the outside of the housing 50b of the earphone 60b on the surface of the housing 50b. The external noise 22 collected by the microphone 100b can be thereby collected in a state close to the noise 22 reaching the pinna through the acoustic path 70. Consequently, the noise cancelling effect according to the FF technique can be further improved.

In this case, examples of the vicinity include a state in which an end of a sound collection surface of the microphone 100b and an end of the connection portion (opening) of the acoustic path 70 on the surface of the housing 50b of the earphone 60b are in contact with each other. In addition to this state, the vicinity can include a state in which the end of the sound collection surface of the microphone 100b and the end of the connection portion (opening) are distant from each other by about several millimeters. For example, it is assumed that the sound collection surface of the microphone 100b has a diameter of 4 mm, and the surface of the housing 50b of the earphone 60b where the microphone 100b and the connection portion (opening) of the acoustic path 70 are provided has a diameter of 10 mm. In this case, when the microphone 100b and the connection portion (opening) of the acoustic path 70 are placed on this surface, the microphone 100b can be considered to be in the vicinity of the connection portion (opening) of the acoustic path 70.

The microphone 100b may be also located in the acoustic path 70 as illustrated in FIG. 5D. In this case, the microphone 100b that is placed at a position distant from the connection portion (opening) of the acoustic path 70 by about several millimeters can be considered to be in the vicinity of the connection portion (opening) of the acoustic path 70.

When the microphone 100b is located in the acoustic path 70, the microphone 100b that is located on the inside of the connection portion (opening) of the acoustic path 70 and closer to the connection portion (opening) than the ventilation resistance body 52 can be considered to be in the vicinity of the connection portion (opening) of the acoustic path 70.

Moreover, when the microphone 100b is located in the acoustic path 70, the microphone 100b that satisfies a condition as described below can be also considered to be in the vicinity of the connection portion (opening) of the acoustic path 70.

That is, referring to FIG. 5E, “Dx” represents the transfer function of sound output from the driver unit 106, reaching a portion 73 connected to the acoustic path 70 through the front-surface space 54b from the driver unit 106 as indicated by a path R. Additionally, “Dy” represents the transfer function of the sound reaching the microphone 100b through the front-surface space 54b and the acoustic path 70 from the driver unit 106 as indicated by a path S. In this case, when the microphone 100b is placed at a position where |Dx|/|Dy| that is a ratio of absolute values of Dx and Dy is higher than about 10 [dB], the microphone 100b can be considered to be in the vicinity of the connection portion (opening) of the acoustic path 70.

Here, when the microphone 100b is mounted at a predetermined position with respect to the connection portion (opening) of the acoustic path 70 on the surface of the housing 50b of the earphone 60b, the microphone 100b needs to be located at a position not causing howling in the earphone 60b. Such a position can be obtained by, for example, experiments.

The vicinity may also include a position of the microphone 100b where a difference between a characteristic of sound collected by the microphone 100b and a characteristic of sound at the connection portion (opening) of the acoustic path 70 on the surface of the housing 50b is equal to or less than a predetermined value. In this case, a measurable value in the transfer function, such as a frequency characteristic, can be used as the characteristic.

Note that a direction of the connection portion (opening) of the acoustic path 70 and a direction perpendicular to the sound collection surface of the microphone 100b are preferably substantially equal to each other.

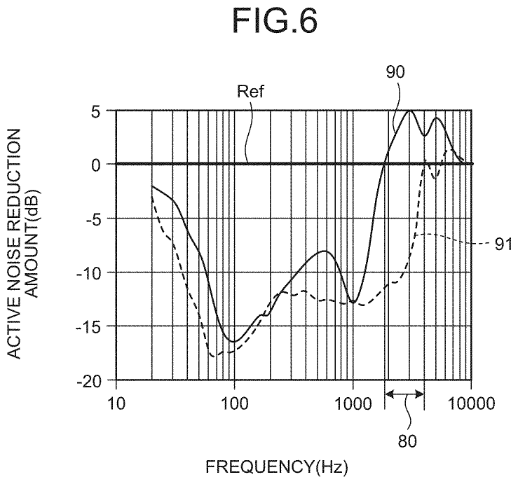

FIG. 6 is a view for explaining the effect according to the first embodiment. In FIG. 6, the horizontal axis represents a frequency [Hz] displayed on a logarithmic scale. The vertical axis represents an active noise reduction amount [dB]. The active noise reduction amount is a noise reduction amount obtained when the noise cancelling system in FIGS. 3A to 3C is operated based on noise reduction amounts in the earphones 60a and 60b obtained in passive sound isolation, i.e., when the noise cancelling system is not operated, as a reference value (Ref).

In FIG. 6, a characteristic line 90 shows a characteristic of the earphone 60a according to the existing technique, described using FIGS. 4A to 4C. Additionally, a characteristic line 91 shows a characteristic of the earphone 60b according to the first embodiment, described using FIGS. 5A to 5C. When the characteristic lines 90 and 91 in FIG. 6 are compared, it is understood that the characteristic line 91 has a larger active noise reduction amount than the characteristic line 90. Especially in a frequency band 80 from approximately 2 [kHz] to approximately 4 [kHz], a reduction effect of 10 [dB] or more can be observed in the active noise reduction amount indicated by the characteristic line 91 with respect to the active noise reduction amount indicated by the characteristic line 90.

As described above, disposing the microphone 100b in the vicinity of the connection portion (opening) of the acoustic path 70 on the surface of the housing 50b allows the noise reaching the pinna from the outside to be further reduced in the FF noise cancelling system.

### First Modification of the First Embodiment

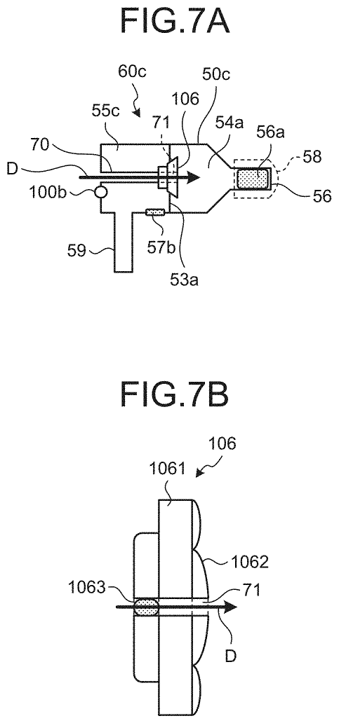

Next, a first modification of the first embodiment will be described. An earphone according to the first modification of the first embodiment will be described using FIGS. 7A and 7B. FIG. 7A is a view illustrating a configuration of an example of an earphone 60c according to the first modification of the first embodiment.

As illustrated in FIG. 7A, the earphone 60c according to the first modification of the first embodiment is provided with a vent hole 71 in, for example, the center of the driver unit 106 so as to penetrate the front surface and the back surface of the driver unit 106. The acoustic path 70 is connected to the vent hole 71 or configured including the vent hole 71 to connect the front-surface space 54a and the outside of a housing 50c of the earphone 60c separately from a back-surface space 55c that is separated from the front-surface space 54a by the partition wall 53a.

FIG. 7B is a view schematically illustrating a structure of an example of the driver unit 106. In the example of FIG. 7B, the driver unit 106 includes a frame 1061, a diaphragm 1062, and a ventilation resistance body 1063. The frame 1061 includes, for example, a magnet and a voice coil connected to the diaphragm 1062. The diaphragm 1062 vibrates according to the audio signal input into the voice coil to output sound. Here, a doughnut-shaped magnet having a hollow center is used as the magnet so as to form a hole in the center of the diaphragm 1062. The vent hole 71 can be thereby formed penetrating the front surface and the back surface of the driver unit 106.

The microphone 100b is disposed in the vicinity of the connection portion (opening) where the acoustic path 70 is connected to the surface of the housing 50c of the earphone 60c in a similar manner to the above first embodiment. Configuring the earphone 60c as described above also allows the noise reaching the pinna from the outside to be further reduced in the FF noise cancelling system in a similar manner to the above first embodiment.

### Second Modification of the First Embodiment

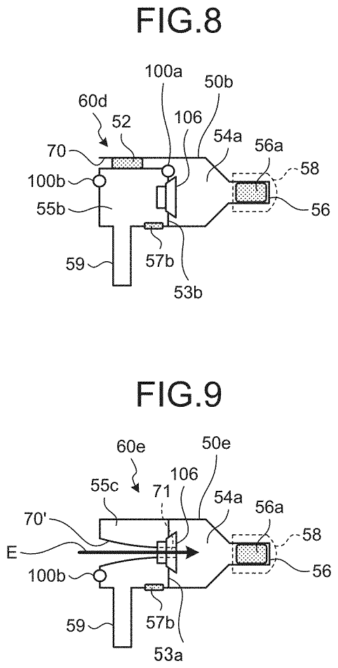

Next, a second modification of the first embodiment will be described. FIG. 8 is a view illustrating a configuration of an earphone example according to the second modification of the first embodiment. An earphone 60d according to the second modification of the first embodiment illustrated in FIG. 8 is provided by adding the microphone 100a for the FB noise cancelling system to the front-surface space 54b in, for example, the earphone 60b according to the first embodiment described using FIG. 5A.

In this configuration, the electrical circuit of the noise cancelling system includes the microphone amplifier, the filter 102a, and the equalizer 103 in FIG. 1A, and the microphone amplifier 101 and the filter 102b in FIG. 3A.

The second modification of the first embodiment enables improvement in stability while reducing the gain and decreasing the noise attenuation in the signal processing circuit using the FB technique, and further enables noise removal using the FF technique. As a result, the noise attenuation in the entire system can be increased, and the system can be stably operated.

While it has been described that the microphone 100a for the FB noise cancelling system is added to the earphone 60b according to the first embodiment, the configuration is not limited to this example. For example, the microphone 100a may be also added to the front-surface space 54a (see FIG. 7A) of the earphone 60c according to the first modification of the first embodiment. The same applies to a configuration in FIG. 9 described below.

### Third Modification of the First Embodiment

Next, a third modification of the first embodiment will be described. FIG. 9 is a view illustrating a configuration of an earphone example according to the third modification of the first embodiment. Note that FIG. 9 shows an example in which the configuration according to the third modification of the first embodiment is applied to the configuration of the earphone 60c according to the first modification of the first embodiment described using FIG. 7A.

While it has been described that the acoustic path 70 has a cylindrical shape in the first embodiment and the first and second modifications of the first embodiment described above, the shape is not limited to this example. An earphone 60e according to the third modification of the first embodiment illustrated in FIG. 9 includes an acoustic path 70′ that connects the front-surface space 54a of the driver unit 106 and the surface of a housing 50e of the earphone 60e. The acoustic path 70′ is shaped such that the opening at the connection portion where the acoustic path 70′ is connected to the surface of the housing 50e has a larger area than an opening at a connection portion where the acoustic path 70′ is connected to the front-surface space 54a.

To be more specific, the acoustic path 70′ has a so-called trumpet shape in which its diameter is increased nonlinearly from the driver unit 106 toward the surface of the housing 50e. In other words, a longitudinal cross section of the acoustic path 70′ according to the third modification of the first embodiment is curved symmetrically to the longitudinal center. The acoustic path 70′ is not limited to this shape, and the longitudinal cross section thereof may be also curved asymmetrically to the longitudinal center.

The microphone 100b is disposed in the vicinity of the connection portion (opening) where the acoustic path 70′ is connected to the surface of the housing 50e of the earphone 60e in a similar manner to the above first embodiment. Configuring the earphone 60e as described above also allows the noise reaching the pinna from the outside to be further reduced in the FF noise cancelling system in a similar manner to the above first embodiment.

Additionally, in the third modification of the first embodiment, the acoustic path 70′ is shaped such that the opening in the surface of the housing 50e has a larger area than the opening connected to the front-surface space 54a as described above. This makes directivity of the acoustic path 70′ against the noise 22 input thereinto close to that of the omni-directional microphone 100b. Thus, improvement in the noise reducing effect according to the FF technique can be expected.

Note that the acoustic path 70′ according to the third modification of the first embodiment can be similarly applied to the earphone 60b according to the first embodiment and the earphone 60d according to the third modification of the first embodiment described above.

### Second Embodiment

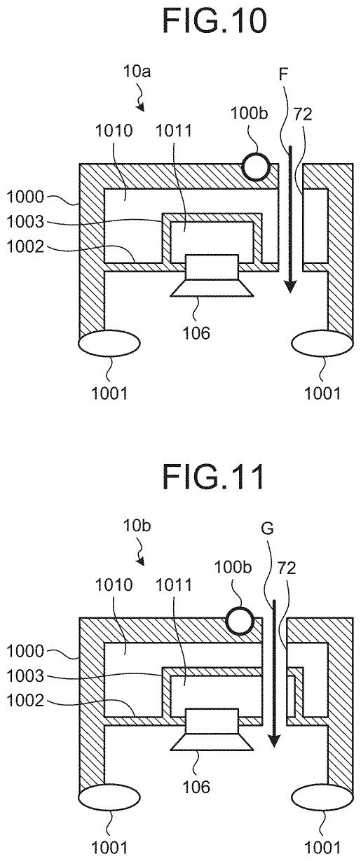

Next, a second embodiment will be described. The second embodiment is an example in which the present disclosure is applied to an over-ear (or on-ear) type headphone. FIG. 10 is a view illustrating a configuration of a headphone example according to the second embodiment. In a headphone 10a according to the second embodiment illustrated in FIG. 10, a housing 1000 is divided into the front surface and the back surface of the driver unit 106 by a partition wall 1002, and the front surface side of the driver unit 106 has an open structure. On the front surface side, an end of the housing 1000 covers the pinna on the head 30 of the listener via an earpad 1001 made of urethane or the like. The front surface of the driver unit 106, a portion of the housing 1000, the earpad 1001, and the head 30 of the listener form the front-surface space (first space) of the driver unit 106.

Additionally, in the example of FIG. 10, a first back-surface space 1010 (second space) is formed by the partition wall 1002 on the back surface side of the driver unit 106 in the housing 1000 of the headphone 10a. Moreover, in the example of FIG. 10, a partition wall 1003 is disposed in the first back-surface space 1010 so as to form a second back-surface space 1011 (third space) including a back-surface portion of the driver unit 106.

In the headphone 10a according to the second embodiment, the front-surface space of the driver unit 106 and the outside of the housing 1000 are connected by an acoustic path 72 that is separated from the first back-surface space 1010 through the first back-surface space 1010. The connection portion (opening) may be covered with a lid made of metal or synthetic resin where a plurality of holes are formed. For example, a cylinder that is opened at an end connected to the partition wall 1002 and an end connected to the outside of the housing 1000 can be used as the acoustic path 72 similarly to the acoustic path 70 in the above first embodiment. Additionally, in the second embodiment, the acoustic path 72 is disposed at a position not in contact with the driver unit 106. A ventilation resistance body made of, for example, urethane foam or non-woven fabric is preferably provided within the acoustic path 72.

The microphone 100b for noise collection using the FF technique is disposed in the vicinity of the connection portion (opening) where the acoustic path 72 is connected to the housing 1000 of the headphone 10a on the surface of the housing 1000 of the headphone 10a. The external noise 22 collected by the microphone 100b can be thereby collected in a state close to the noise 22 reaching the pinna through the acoustic path 72 (see a path F in FIG. 10). Consequently, the noise cancelling effect according to the FF technique can be further improved.

Note that the definition of the vicinity described in the first embodiment can be applied to the vicinity in this case. Here, in the headphone 10a, the area of the surface of the housing 1000 where the connection portion of the acoustic path 72 and the microphone 100b are provided can be made larger than that of the above earphone 60b or the like. Thus, a larger distance margin of, for example, several tens millimeters can be provided between the end of the sound collection surface of the microphone 100b and the end of the opening of the acoustic path 72 in the surface of the housing 1000 as compared with that in the example of the above earphone 60b.

Note that a direction of the connection portion (opening) of the acoustic path 72 and a direction perpendicular to the sound collection surface of the microphone 100b are preferably substantially equal to each other in this case as well.

### First Modification of the Second Embodiment

Next, a first modification of the second embodiment will be described. FIG. 11 is a view illustrating a configuration of a headphone example according to the first modification of the second embodiment. In a headphone 10b illustrated in FIG. 11, the housing 1000 is divided into the front surface and the back surface of the driver unit 106 by the partition wall 1002, and the second back-surface space 1011 is formed by the partition wall 1003 within the first back-surface space 1010 formed by the housing 1000 and the partition wall 1002 on the back surface of the driver unit 106 in a similar manner to the headphone 10a described using FIG. 10.

In the headphone 10b according to the first modification of the second embodiment, the front-surface space of the driver unit 106 and the outside of the housing 1000 are connected by the acoustic path 72 that is separated from the second back-surface space 1011 and the first back-surface space 1010.

The microphone 100b is disposed in the vicinity of the connection portion (opening) where the acoustic path 72 is connected to the housing 1000 of the headphone 10b on the surface of the housing 1000 of the headphone 10b in a similar manner to the above second embodiment. The external noise 22 collected by the microphone 100b can be thereby collected in a state close to the noise 22 reaching the pinna through the acoustic path 72 (see a path G in FIG. 11). Consequently, the noise cancelling effect according to the FF technique can be further improved.

### Second Modification of the Second Embodiment

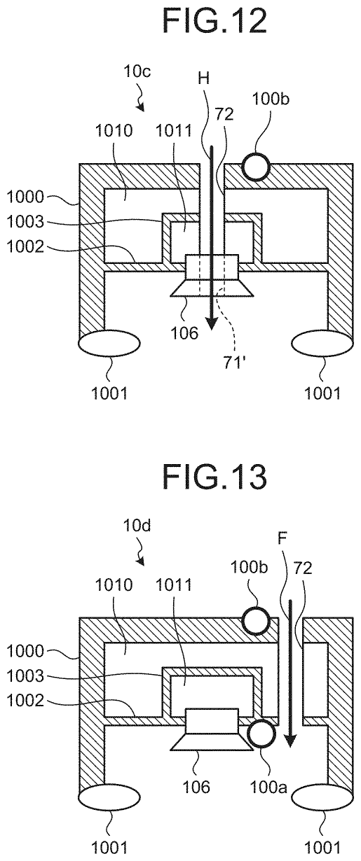

Next, a second modification of the second embodiment will be described. FIG. 12 is a view illustrating a configuration of a headphone example according to the second modification of the second embodiment. A headphone 10c illustrated in FIG. 12 corresponds to the earphone 60c (see FIG. 7A) according to the above first modification of the first embodiment, and is provided with the vent hole 71 in, for example, the center of the driver unit 106 so as to penetrate the front surface and the back surface of the driver unit 106. The acoustic path 72 is connected to the vent hole 71 or configured including the vent hole 71 to connect the front-surface space of the driver unit 106 and the outside of the housing 1000 of the headphone 10c through the second back-surface space 1011 and the first back-surface space 1010.

Since the driver unit 106 has the same structure as that described using FIG. 7B, the detailed description thereof is omitted here.

The microphone 100b is disposed in the vicinity of the connection portion (opening) where the acoustic path 72 is connected to the housing 1000 of the headphone 10b on the surface of the housing 1000 of the headphone 10b in a similar manner to the above second embodiment. The external noise 22 collected by the microphone 100b can be thereby collected in a state close to the noise 22 reaching the pinna through the acoustic path 72 (see a path H in FIG. 12). Consequently, the noise cancelling effect according to the FF technique can be further improved.

### Third Modification of the Second Embodiment

Next, a third modification of the second embodiment will be described. FIG. 13 is a view illustrating a configuration of a headphone example according to the third modification of the second embodiment. A headphone 10d according to the third modification of the second embodiment illustrated in FIG. 13 is provided by adding the microphone 100a for the FB noise cancelling system to the front-surface space of the driver unit 106 in, for example, the headphone 10a according to the second embodiment described using FIG. 10.

In this example, the electrical circuit of the noise cancelling system includes the microphone amplifier, the filter 102a, and the equalizer 103 in FIG. 1A, and the microphone amplifier 101 and the filter 102b in FIG. 3A in a similar manner to the above second modification of the first embodiment.

The third modification of the second embodiment enables improvement in stability while reducing the gain and decreasing the noise attenuation in the signal processing circuit using the FB technique, and further enables noise removal using the FF technique. As a result, the noise attenuation in the entire system can be increased, and the system can be stably operated.

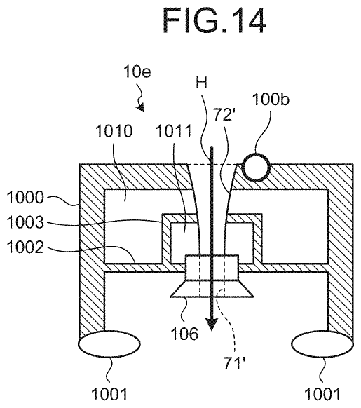

While it has been described that the microphone 100a for the FB noise cancelling system is added to the headphone 10a according to the second embodiment, the configuration is not limited to this example. For example, the microphone 100a may be also added to the front-surface space of the driver unit 106 in the headphone 10b according to the first modification of the second embodiment and the headphone 10c according to the second modification of the second embodiment. The same applies to a configuration in FIG. 14 described below.

### Fourth Modification of the Second Embodiment

Next, a fourth modification of the second embodiment will be described. FIG. 14 is a view illustrating a configuration of a headphone example according to the fourth modification of the second embodiment. Note that FIG. 14 shows an example in which the configuration according to the fourth modification of the second embodiment is applied to the configuration of the headphone 10c according to the second modification of the second embodiment described using FIG. 12.

A headphone 10e illustrated in FIG. 14 corresponds to the earphone 60e (see FIG. 9) according to the above third modification of the first embodiment. An acoustic path 72′ that connects the front-surface space of the driver unit 106 and the surface of 1000 of the headphone 10d is shaped such that the opening at the connection portion where the acoustic path 72′ is connected to the surface of the housing 1000 has a larger area than an opening at a connection portion where the acoustic path 72′ is connected to the front-surface space of the driver unit 106.

To be more specific, the acoustic path 72′ has a so-called trumpet shape in which its diameter is increased nonlinearly from the driver unit 106 toward the surface of the housing 1000 similarly to the acoustic path 70′ in FIG. 9. In other words, a longitudinal cross section of the acoustic path 72′ according to the fourth modification of the second embodiment is curved symmetrically to the longitudinal center. The acoustic path 72′ is not limited to this shape, and the longitudinal cross section thereof may be also curved asymmetrically to the longitudinal center.

The microphone 100b is disposed in the vicinity of the connection portion (opening) where the acoustic path 72′ is connected to the surface of the housing 1000 of the headphone 10e in a similar manner to the above first embodiment. Configuring the headphone 10e as described above also allows the noise reaching the pinna from the outside to be further reduced in the FF noise cancelling system in a similar manner to the above second embodiment.

Additionally, in the fourth modification of the second embodiment, the acoustic path 72′ is shaped such that the opening in the surface of the housing 1000 has a larger area than the opening connected to the front-surface space of the driver unit 106 as described above. This makes directivity of the acoustic path 72′ against the noise 22 input thereinto close to that of the omni-directional microphone 100b. Thus, improvement in the noise reducing effect according to the FF technique can be expected.

Note that the acoustic path 72′ according to the fourth modification of the third embodiment can be similarly applied to the headphone 10a according to the second embodiment, the headphone 10b according to the first modification of the second embodiment, and the headphone 10d according to the third modification of the second embodiment described above.

### Fifth Modification of the Second Embodiment

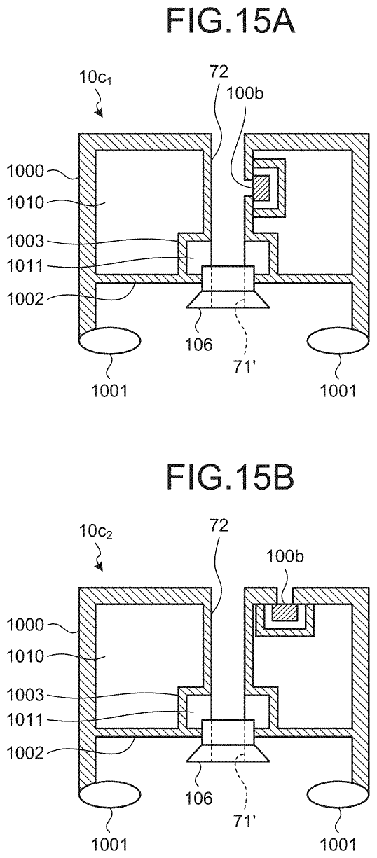

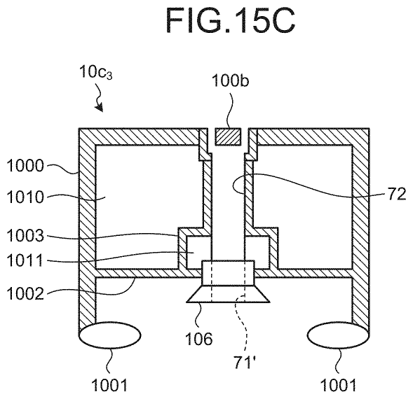

Next, a fifth modification of the second embodiment will be described. In the fifth modification of the second embodiment, a position where the microphone 100b is disposed will be described using FIGS. 15A to 15C. Here, the headphone 10c according to the second modification of the second embodiment described using FIG. 12 will be described as an example.

FIG. 15A shows an example in which the microphone 100b for noise collection using the FF technique is disposed on an inner surface of the acoustic path 72, more specifically, on an inner wall of the acoustic path 72. In this case, the microphone 100b is preferably placed such that the sound collection surface is located in the vicinity of the connection position of the acoustic path 72 with the housing 1000. Additionally, when the microphone 100b is disposed on the inner wall of the acoustic path 72, for example, the sound collection surface of the microphone 100b is preferably disposed parallel to the inner wall of the acoustic path 72.

FIG. 15B shows an example in which the microphone 100b is arranged flush with the surface of the connection portion (opening) where the acoustic path 72 is connected to the housing 1000 in the housing 1000 of the headphone 10c. In other words, the sound collection surface of the microphone 100b is placed toward the outside of the housing 1000 in the example of FIG. 15B. The microphone 100b is disposed in the vicinity of the connection portion (opening) where the acoustic path 72 is connected to the housing 1000 in the example of FIG. 15B as well. Additionally, the flush surface is, for example, a surface without an edge of a predetermined angle or more with respect to the surface of the connection portion (opening).

FIG. 15C shows an example in which the microphone 100b is placed in the opening at the connection portion where the acoustic path 72 is connected to the housing 1000. In this case, the diameter of the opening is increased according to need such that the microphone 100b does not close the acoustic path 72. The arrangement in FIG. 15C is considered to be more advantageous than the arrangement examples in FIGS. 15A and 15B in a sense that the microphone 100b is placed in the vicinity of the opening at the connection portion where the acoustic path 72 is connected to the housing 1000.

While the headphone 10c has been described as an example, the respective positions of the microphone 100b described using FIGS. 15A to 15C can be also applied to the headphones 10a, 10b, 10d, and 10e illustrated in FIGS. 10, 11, 13, and 14, respectively.

Moreover, the respective positions of the microphone 100b described using FIGS. 15A to 15C can be similarly applied to the earphones 60b, 60c, 60d, and 60e illustrated in FIGS. 5A, 7A, 8, and 9, respectively, in the first embodiment and its respective modifications.

The present disclosure can be also configured as follows.

(1) A sound output device comprising:

an acoustic path connecting a first space on a front surface of a driver unit and an outside of a housing including the driver unit separately from a second space on a back surface of the driver unit; and

a microphone disposed in the vicinity of an opening where the acoustic path is connected to the outside of the housing.

(2) The sound output device according to the above (1), wherein

the acoustic path connects the first space and the outside separately from the second space while penetrating the driver unit and a portion of the second space.

(3) The sound output device according to the above (1), wherein

the acoustic path connects the first space and the outside separately from the second space without contacting the driver unit.

(4) The sound output device according to any one of the above (1) to (3), wherein

the second space includes a third space connected to the back surface of the driver unit, and

the acoustic path connects the first space and the outside separately from the third space and the second space.

(5) The sound output device according to any one of the above (1) to (4), wherein

in the acoustic path, an area of an end connected to the outside and an area of an end connected to the first space are substantially equal to each other.

(6) The sound output device according to any one of the above (1) to (4), wherein

in the acoustic path, an area of a first end connected to the outside is larger than an area of a second end connected to the first space.

(7) In the sound output device according to the above (6), the acoustic path has a sectional area that increases nonlinearly from the second end toward the first end.
(8) The sound output device according to any one of the above (1) to (7), wherein

the microphone is disposed in the vicinity of the opening on a surface of the housing.

(9) The sound output device according to any one of the above (1) to (7), wherein

the microphone is disposed on an inner surface of the acoustic path.

(10) The sound output device according to any one of the above (1) to (7), wherein

the microphone is disposed in the opening of the acoustic path.

(11) The sound output device according to any one of the above (1) to (10), further comprising

a microphone disposed at a position enabling direct collection of sound in the first space.

(12) The sound output device according to any one of the above (1) to (11), wherein

the housing is shaped such that the first space is opened in a direction of the front surface of the driver unit.

(13) The sound output device according to any one of the above (1) to (11), wherein

the housing is shaped such that an opening having a smaller area than an area of the front surface of the driver unit is disposed in a direction of the front surface of the driver unit in the first space.

(14) In the sound output device according to any one of the above (1) to (13), the microphone is placed at a position where a difference between a characteristic of sound at the opening and a characteristic of sound collected by the microphone is equal to or less than a predetermined value.

### REFERENCE SIGNS LIST

10a, 10b, 10c, 10d, 10e, 10_{FB}, 10_{FF} HEADPHONE
20, 20′ CONTROL POINT
21 SOUND PRESSURE
22, 23 NOISE
50a, 50b, 50c, 50e, 1000 HOUSING
53a, 53b, 1002, 1003 PARTITION WALL
60a, 60b, 60c, 60d, 60e EARPHONE
70, 70′, 72, 72′ ACOUSTIC PATH
101a′, 101b′ MICROPHONE/MICROPHONE AMPLIFIER
100a, 100b MICROPHONE
101 MICROPHONE AMPLIFIER
102a, 102b FILTER
103 EQUALIZER
105 POWER AMPLIFIER
106 DRIVER UNIT
120, 130, 131 SPATIAL TRANSFER FUNCTION

1. A sound output device comprising:
an acoustic path connecting a first space on a front surface of a driver unit and an outside of a housing including the driver unit separately from a second space on a back surface of the driver unit; and
a microphone disposed in the vicinity of an opening where the acoustic path is connected to the outside of the housing.

2. The sound output device according to claim 1, wherein
the acoustic path connects the first space and the outside separately from the second space while penetrating the driver unit and a portion of the second space.

3. The sound output device according to claim 1, wherein
the acoustic path connects the first space and the outside separately from the second space without contacting the driver unit.

4. The sound output device according to claim 1, wherein
the second space includes a third space connected to the back surface of the driver unit, and
the acoustic path connects the first space and the outside separately from the third space and the second space.

5. The sound output device according to claim 1, wherein
in the acoustic path, an area of an end connected to the outside and an area of an end connected to the first space are substantially equal to each other.

6. The sound output device according to claim 1, wherein
in the acoustic path, an area of an end connected to the outside is larger than an area of an end connected to the first space.

7. The sound output device according to claim 1, wherein
the microphone is disposed in the vicinity of the opening on a surface of the housing.

8. The sound output device according to claim 1, wherein
the microphone is disposed on an inner surface of the acoustic path.

9. The sound output device according to claim 1, wherein
the microphone is disposed in the opening of the acoustic path.

10. The sound output device according to claim 1, further comprising
a microphone disposed at a position enabling direct collection of sound in the first space.

11. The sound output device according to claim 1, wherein
the housing is shaped such that the first space is opened in a direction of the front surface of the driver unit.

12. The sound output device according to claim 1, wherein
the housing is shaped such that an opening having a smaller area than an area of the front surface of the driver unit is disposed in a direction of the front surface of the driver unit in the first space.
